(19) United States
(12) Patent Application Publication
(10) Pub. No.: US 2023/0048952 A1
(43) Pub. Date: Feb. 16, 2023

(54) IMAGE REGISTRATION METHOD AND ELECTRONIC DEVICE

(71) Applicant: BEIJING DAJIA INTERNET INFORMATION TECHNOLOGY CO., LTD., Beijing (CN)

(72) Inventors: Zairan WANG, Beijing (CN); Xiaoyan GUO, Beijing (CN)

(21) Appl. No.: 17/975,768

(22) Filed: Oct. 28, 2022

Related U.S. Application Data
(63) Continuation of application No. PCT/CN2020/138909, filed on Dec. 24, 2020.

(30) Foreign Application Priority Data
May 25, 2020 (CN) 202010453236.6

(51) Int. Cl. G06T 7/33; G06T 7/70; G06V 10/25; G06V 10/44; G06V 10/74; G06F 16/532

(52) U.S. Cl. CPC G06T 7/337; G06T 7/70; G06V 10/25; G06V 10/44; G06V 10/761; G06F 16/532; G06V 2201/07; G06T 2207/20164

(57) ABSTRACT

An image registration method includes: acquiring a target image comprising a target object; inputting the target image to a preset network model, and outputting position information and rotation angle information of the target object; obtaining a reference image comprising the target object by querying a preset image database according to the position information and the rotation angle information; and performing image registration on the target image and the reference image to obtain a corresponding position of the target object of the target image in the reference image.

### CROSS-REFERENCE TO RELATED APPLICATION

The application is a continuation of International Application No. PCT/CN2020/138909, filed on Dec. 24, 2020, which claims priority to Chinese Patent Application No. 202010453236.6, filed with the China National Intellectual Property Administration on May 25, 2020, the entire disclosures of which are incorporated herein by reference.

### FIELD

The present disclosure relates to the technical field of image processing, and more particularly to an image registration method and an electronic device.

### BACKGROUND

Image registration is a typical problem and technical difficulty in the field of image processing research, and its purpose is to compare or fuse images acquired under different conditions for the same object. Different conditions can refer to different acquisition devices, different times, different shooting angles and distances, etc. Specifically, the image registration is a technique that compares two images selected from a set of images, and maps one image to the other through a spatial transformation relationship to allow the points in the two images corresponding to the same location in space to be corresponded to each other, thus achieving information fusion. The image registration is widely used in computer vision, augmented reality and other fields.

### SUMMARY

According to a first aspect of embodiments of the present disclosure, there is provided an image registration method, the method including: acquiring a target image including a target object; inputting the target image to a preset network model, and outputting position information and rotation angle information of the target object; obtaining a reference image including the target object by querying a preset image database according to the position information and the rotation angle information; and performing image registration on the target image and the reference image to obtain a corresponding position of the target object of the target image in the reference image.

According to a second aspect of embodiments of the present disclosure, there is provided an electronic device, including: a processor; and a memory for storing instructions executable by the processor. The processor is configured to execute the instructions to implement the image registration method as described in the first aspect.

According to a third aspect of embodiments of the present disclosure, there is provided a storage medium having stored therein instructions that, in response to the instructions being executed by a processor of an electronic device, cause the electronic device to execute the image registration method as described in the first aspect.

It should be understood that the above general description and the later detailed description are explanatory only and do not limit the present disclosure.

### BRIEF DESCRIPTION OF THE DRAWINGS

The accompanying drawings herein are incorporated into and constitute part of the description, illustrate embodiments consistent with the present disclosure, and are used together with the description to explain the principles of the present disclosure, and do not constitute an undue limitation of the present disclosure.

FIG. 1 is a flow diagram showing an image registration method according to an embodiment.

FIG. 2 is a flow schematic diagram showing an image registration method that is resistant to scale and perspective changes according to an embodiment.

FIG. 3 is a block diagram showing an image registration apparatus according to an embodiment.

FIG. 4 is a block diagram showing an image registration electronic device according to an embodiment.

FIG. 5 is a block diagram showing an electronic device for image registration according to an embodiment.

### DETAILED DESCRIPTION

In order to make those skilled in the art better understand the technical solutions of the present disclosure, the technical solutions in the embodiments of the present disclosure will be clearly and completely described below with reference to accompanying drawings.

It should be noted that the terms “first”, “second”, etc. in the description and claims of the present disclosure and the above accompanying drawings are used to distinguish similar objects, and are not necessarily used to describe a particular order or sequence. It should be understood that the data so used may be interchanged under appropriate circumstances, such that embodiments of the present disclosure described herein can be implemented in an order other than those illustrated or described herein. The embodiments described in the following embodiments are not intended to represent all embodiments consistent with the present disclosure. Rather, they are only examples of devices and methods that are consistent with some aspects of the present disclosure, as detailed in the appended claims.

FIG. 1 is a flow diagram showing an image registration method according to an embodiment. As shown in FIG. 1, the image registration method may include the following steps.

In block S11, a target image including a target object is acquired.

In the embodiment of the present disclosure, the target image may include one or more target objects, and the target objects may be people, animals, plants, vehicles, buildings, natural landscapes, and so on. The target image may be a picture in any format or a frame in a video stream, and the embodiment of the present disclosure does not impose specific limitations on the classification of the target object, the format, size, resolution, etc. of the target image.

In an embodiment of the present disclosure, after the target image including the target object is acquired, a pre-processing operation can be performed on the target image, for example, noise reduction processing is performed on the target image.

In block S12, the target image is input to a preset network model, and position information and rotation angle information of the target object are output.

In an embodiment of the present disclosure, a network model can be established and trained in advance, which is used to output information, such as the position information and the rotation angle information of the object in the image, for the input image. For example, an initial deep convolutional network model is established in advance, a training sample data is input to the deep convolutional network model, and parameters of each layer of the deep convolutional network model are iteratively adjusted according to the output results until the output results of the adjusted deep convolutional network model meet set requirements. The training sample data may include a large number of training images, and the training images may or may not include training objects. In response to the training images including training objects, the training images may include one or more training objects. Moreover, the training images can include training objects of different scales and different perspectives. The training sample data may also include training position information and training rotation angle information corresponding to each training image. The training position information represents position information of the training object in the training image, and a scale of the training object can be determined by the position information, and the scale can be understood as the size of the training object. Generally speaking, in a case that a training object is photographed, a scale of the imaged training object is relatively large as a camera is close to the training object, and a scale of the imaged training object is relatively small as the camera is far away from the training object. The detection of the training object has scale invariance, that is, regardless of whether the scale of the training object is large or small, the position information of the training object in the training image can be detected. The training rotation angle information represents a perspective of the training object in the training image. The perspective can be understood as an angle of the training object in the three-dimensional space where the training object is located in the training image.

In an embodiment of the present disclosure, the location information may include coordinate information of a minimum enclosing rectangle encompassing the target object in the target image. In some embodiments, the coordinate information includes at least the coordinate information of two vertexes on a diagonal of the minimum enclosing rectangle. In practical application, the position information can be represented by loc_{gt}=(x₀, y₀, x₁, y₁), where loc_{gt} represents the position information, x₀ represents an abscissa value of an upper-left corner coordinate point of the minimum enclosing rectangle, y₀ represents an ordinate value of the upper-left corner coordinate point of the minimum enclosing rectangle; x₁ represents an abscissa value of a lower-right corner coordinate point of the minimum enclosing rectangle, and y₁ represents an ordinate value of the lower-right coordinate point of the minimum enclosing rectangle.

In an embodiment of the present disclosure, the rotation angle information may include azimuth angle information, elevation angle information, and roll angle information of the target object. In practical application, the rotation angle information can be represented by R_{gt}=(θ,ϕ,ψ), where R_{gt} represents the rotation angle information, θ represents the azimuth angle information, ϕ represents the elevation angle information, and ψ represents the roll angle information.

In an embodiment of the present disclosure, for each input image, the above-mentioned network model can also be used to output type information of the object in the image. Correspondingly, in the training process of the above-mentioned network model, the training sample data may further include training type information corresponding to each training image. The training type information represents an object type to which the training object belongs. In practical applications, the object type can be a water cup, a television, a cell phone, a car, etc., and the embodiments of the present disclosure do not impose specific limitations on the classification of object types.

In block S13, a reference image including the target object is obtained by querying a preset image database according to the position information and the rotation angle information.

In an embodiment of the present disclosure, one or more sample images of one or more sample object are stored in the preset image database. Each sample image may include a sample object having a scale and/or a perspective different from other sample images.

The reference image obtained by querying in block S13 can be understood as an image similar to the target image. In some embodiments, the reference image is obtained by querying the image database to search for an image that satisfies the following three conditions. In a first aspect, the reference object in the reference image belongs to the same object type as the target object in the target image. In a second aspect, a scale of the reference object in the reference image is similar to a scale of the target object in the target image. In a third aspect, a perspective of the reference object in the reference image is similar to that of the target object in the target image.

In an embodiment of the present disclosure, in response to determining that at least one sample image of one sample object is stored in the preset image database and this one sample object belongs to a same object type as the target object, the image database can be queried to obtain the reference image satisfying a preset scale condition and a preset perspective condition.

The above scale condition may indicate that a difference between a scale corresponding to the position information of the target object and a scale of the sample object is within a preset scale range. For example, a scale of the target object is 100 square pixels, a scale of the sample object is 95 square pixels, and a difference between a scale of the target object and a scale of the sample object is within the scale range of −5 to 5 square pixels.

The above perspective condition may indicate that a difference between a perspective corresponding to the rotation angle information of the target object and a perspective of the sample object is within a preset perspective range. For example, a perspective of the target object is 50°, a perspective of the sample object is 45°, and a difference between the perspective of the target object and the perspective of the sample object is within the perspective range of −5° to 5°.

In an embodiment of the present disclosure, in response to determining that sample images of a plurality of sample objects are stored in the preset image database and at least one of the plurality of sample objects belongs to a same object type as the target object, the image database can be queried to obtain same-type sample images that include a sample object that belongs to the same object type as the target object. For example, the object type of the target object is a cup, and on this basis, the image database is queried to obtain same-type sample images, i.e., sample images having an object type of a cup. The reference image satisfying a preset scale condition and a preset perspective condition is selected from these same-type sample images.

In the process of querying the image database to obtain the same-type sample images that have the same object type as the target object, the object type of the target object can be obtained, and the image database is queried to obtain the same-type sample image according to the object type. The object type of the target object may be obtained by inputting the target image to a network model and the object type of the target object can be output.

In block S4, image registration is performed on the target image and the reference image to obtain a corresponding position of the target object of the target image in the reference image.

In an embodiment of the present disclosure, during the image registration on the target image and the reference image, an object image can be determined from the target image according to the position information of the target object, and the image registration is performed on the object image and the reference image. The above object image may be a minimum enclosing rectangle (located according to the position information of the target object) encompassing the target object of the target image, that is, the minimum enclosing rectangle located in the target image is determined as the object image.

Image registration can be classified into relative image registration and absolute image registration. The relative image registration refers to selecting one image from the plurality of images as a reference image, and performing image registration on the target image and the reference image. In this case, any coordinate system may be used. The absolute image registration refers to defining a control grid, and performing image registration on all images relative to the grid. In the embodiments of the present disclosure, the image registration refers to the relative image registration. The relative image registration is performed by using information in the image, and it can be classified into three methods: gray information method, transform domain method and feature method. In an embodiment of the present disclosure, the image registration performed on the object image and the reference image may be realized by the feature method. In a practical application, a first feature descriptor and a second feature descriptor of the target object can be extracted from the object image and the reference image, respectively. Feature descriptor represents useful information in an image and does not include useless information. In some embodiments, scale-invariant feature transform (SIFT) algorithm can be used to extract the first feature descriptor and the second feature descriptor. A distance between the first feature descriptor and the second feature descriptor is calculated. The distance can be Euclidean distance or Hamming distance, etc. The first feature descriptor and the second feature descriptor is determined as a feature point pair in response to determining that the distance satisfies a preset distance condition. A transformation matrix between the object image and the reference image (i.e., a camera posture change matrix between the two images) is calculated according to the feature point pair and Perspective N Point (PNP) algorithm. The object image is mapped to the reference image according to the transformation matrix. Points in the object image and the reference image corresponding to a some position in space correspond to each other.

The target object included in the object image is mapped to the reference image according to the transformation matrix as the following formula:

I₂=M*I₁

where I₂ represents the object image, I₁ represents the reference image, and M represents the transformation matrix.

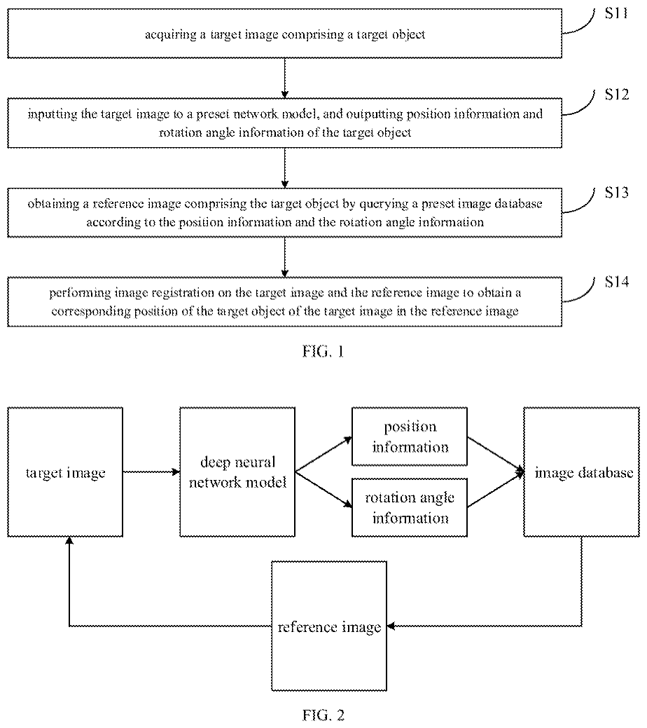

Based on the above description related to the image registration method, an image registration method that is resistant to scale and perspective changes is described below. As shown in FIG. 2, a flow schematic diagram showing an image registration method that is resistant to the scale and the perspective changes. The method detects position information of a target object in a target image by using a deep neural network model and predicts rotation angle information of the target object in three dimensions. A scale of the target object can be obtained through the position information of the target object in the target image, and a perspective of the target object can be obtained through the rotation angle information of the target object in the three dimensions. A reference image that is close to the perspective of the target image is selected from an image database, and the image registration is performed on the two images (the target image and the reference image), which can solve the problem of low accuracy of image registration caused by the inability to extract enough feature descriptors in the case of the scale and the perspective changes, i.e., the images having different scales and different perspectives.

In the embodiments of the present disclosure, the target image including the target object is input to a preset network model, and the model outputs position information and rotation angle information of the target object. A reference image including the target object is obtained by querying a preset image database according to the position information and the rotation angle information. A scale of the target object in the reference image is similar to a scale of the target object in the target image, and a perspective of the target object in the reference image is similar to a perspective of the target object in the target image. Image registration is performed on the target image and the reference image to obtain a corresponding position of the target object of the target image in the reference image.

In the embodiments of the present disclosure, the network model is used to determine the position information and the rotation angle information of the target object in the target image, and with the position information and the rotation angle information, the image database is queried to search for the reference image with a similar scale and a similar perspective to the target image. That is, the scale and the perspective of the target object in the reference image do not change much from the scale and the perspective of the target object in the target image, so that a sufficient number of feature descriptors can be extracted from the target image and the reference image, thereby improving the accuracy of the image registration.

In the present disclosure embodiments, one or more sample images of one type of sample objects, or sample images of more than one types of sample objects are stored in the preset image database. After the object type of the target object is predicted by using the deep convolutional network model, an image database corresponding to the object type of the target object can be selected, alternatively, a sample image corresponding to the object type of the target object can be selected from the image database. In a ease where a sample object of a certain object type is widely used, an image database stored with one or more sample images of such an object type can be established in advance. In a ease where a sample object of a certain object type is not widely used, one or more sample images of such an object type can be stored into an image database including sample images of a plurality of object types.

In the embodiments of the present disclosure, the object image is determined from the target image, and image registration is performed on the object image and the reference image. A size of the object image is smaller than that of the target image, and the image registration is performed on the smaller size object image and the reference image, which reduces the amount of data to be calculated and improves the speed of the image registration.

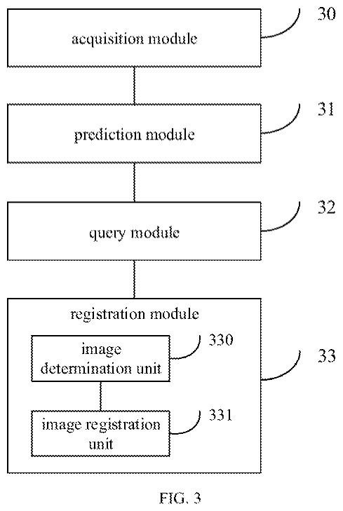

FIG. 3 is a block diagram showing an image registration apparatus according to an embodiment. Referring to FIG. 3, the apparatus may include the following units and modules.

An acquisition module 30 is configured to acquire a target image including a target object.

A prediction module 31 is configured to input the target image to a preset network model, and output position information and rotation angle information of the target object.

A query module 32 is configured to obtain a reference image including the target object by querying a preset image database according to the position information and the rotation angle information.

A registration module 33 is configured to perform image registration on the target image and the reference image to obtain a corresponding position of the target object of the target image in the reference image.

In an embodiment of the present disclosure, one or more sample images of one or more sample objects are stored in the preset image database, and each sample image includes a sample object having a scale and/or a perspective different from other sample images.

In an embodiment of the present disclosure, the query module 32 is configured to, in response to determining that at least one sample image of one sample object is stored in the preset image database and this one sample object belongs to a same object type as the target object, query the image database to obtain the reference image satisfying a preset scale condition and a preset perspective condition. The preset scale condition indicates that a difference between a scale corresponding to the position information of the target object and a scale of the sample object is within a preset scale range; and the preset perspective condition indicates that a difference between a perspective corresponding to the rotation angle information of the target object and a perspective of the sample object is within a preset perspective range.

In an embodiment of the present disclosure, the query module 32 is configured to, in response to determining that sample images of a plurality of sample objects are stored in the preset image database and at least one of the plurality of sample objects belongs to a same object type as the target object, query the image database to obtain same-type sample images comprising a sample object that belongs to the same object type as the target object, and query the same-type sample images to obtain the reference image satisfying a preset scale condition and a preset perspective condition. The preset scale condition indicates that a difference between a scale corresponding to the position information of the target object and a scale of the sample object is within a preset scale range; and the preset perspective condition indicates that a difference between a perspective corresponding to the rotation angle information of the target object and a perspective of the sample object is within a preset perspective range.

In an embodiment of the present disclosure, the query module 32 is configured to acquire an object type of the target object; and query the image database to obtain the same type sample image according to the object type.

In an embodiment of the present disclosure, the query module 32 is configured to input the target image to the network model, and output the object type of the target object.

In an embodiment of the present disclosure, the registration module 33 includes: an image determination unit 330 configured to determine an object image from the target image according to the position information, the object image including the target object; and an image registration unit 331 configured to perform image registration on the object image and the reference image.

In an embodiment of the present disclosure, the image determination unit 330 is configured to locate a minimum enclosing rectangle encompassing the target object in the target image according to the position information; and determine the minimum enclosing rectangle located in the target image as an object image.

In an embodiment of the present disclosure, the image registration unit 331 includes: an extraction sub-module configured to extract a first feature descriptor and a second feature descriptor of the target object from the object image and the reference image, respectively; a calculation sub-module configured to calculate a distance between the first feature descriptor and the second feature descriptor; a screening sub-module configured to determine the first feature descriptor and the second feature descriptor as a feature point pair in response to determining that the distance satisfies a preset distance condition, in which the calculation sub-module is further configured to calculate a transformation matrix between the object image and the reference image according to the feature point pair and PNP algorithm; and a mapping sub-module configured to map the object image to the reference image according to the transformation matrix, in which points in the object image and the reference image corresponding to a same position in space correspond to each other.

In an embodiment of the present disclosure, the position information includes coordinate information of the minimum enclosing rectangle of the target object in the target image, the coordinate information at least includes coordinate information of two vertexes on a diagonal of the minimum enclosing rectangle, and the rotation angle information includes azimuth angle information, elevation angle information and roll angle information of the target object.

With respect to the apparatus in the above embodiments, the specific manners for performing operations for individual units and individual modules therein have been described in detail in the embodiments regarding the methods, which will not be elaborated herein.

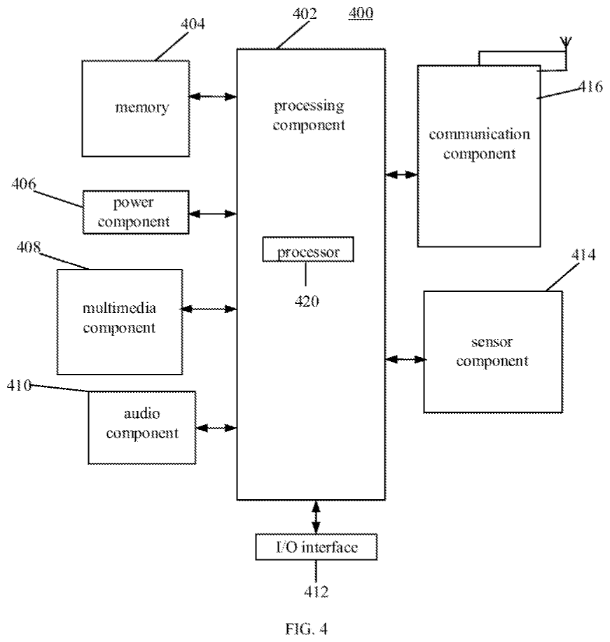

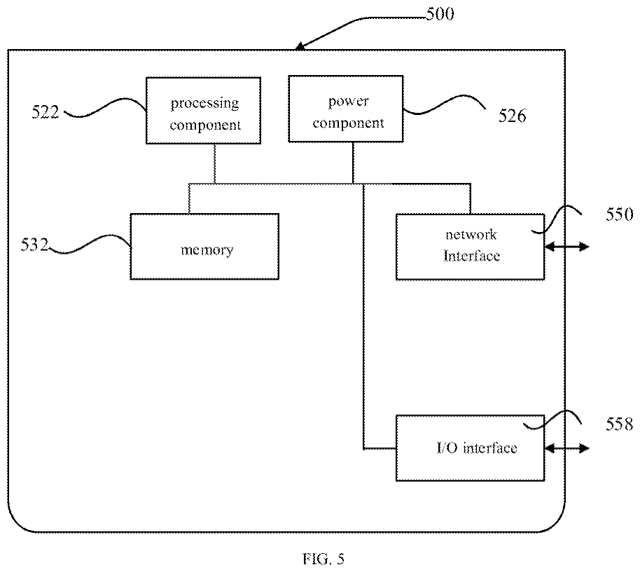

FIG. 4 is a block diagram showing an image registration electronic device 400 according to an embodiment. For example, the electronic device 400 may be a mobile phone, a computer, a digital broadcast terminal, a messaging device, a game console, a tablet device, a medical device, a fitness device, a personal digital assistant, and the like.

Referring to FIG. 4, the electronic device 400 may include one or more of the following components: a processing component 402, a memory 404, a power component 406, a multimedia component 408, an audio component 410, an input/output (I/O) interface 412, a sensor component 414, and a communication component 416.

The processing component 402 typically controls overall operations of the electronic device 400, such as the operations associated with display, phone calls, data communications, camera operations, and recording operations. The processing component 402 can include one or more processors 420 to execute instructions to perform all or some of the steps in the above described methods. Moreover, the processing component 402 may include one or more modules which facilitate the interaction between the processing component 402 and other components. For instance, the processing component 402 may include a multimedia module to facilitate the interaction between the multimedia component 408 and the processing component 402.

The memory 404 is configured to store various types of data to support the operation of the electronic device 400. Examples of such data include instructions for any applications or methods operated on the electronic device 400, contact data, phonebook data, messages, pictures, videos, etc. The memory 404 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 406 provides power to various components of the electronic device 400. The power component 406 may include a power management system, one or more power sources, and any other components associated with the generation, management, and distribution of power in the electronic device 400.

The multimedia component 408 includes a screen providing an output interface between the electronic device 400 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensor may not only sense a boundary of a touch or swipe action, but also sense a period of time and a pressure associated with the touch or swipe action. In some embodiments, the multimedia component 408 includes a front camera and/or a rear camera. The front camera and/or the rear camera may receive external multimedia data while the electronic device 400 is in an operation mode, such as a photographing mode or a video mode. Each of the front camera and the rear camera may be a fixed optical lens system or have focus and optical zoom capability.

The audio component 410 is configured to output and/or input audio signals. For example, the audio component 410 includes a microphone (MIC) configured to receive an external audio signal when the electronic device 400 is in an operation mode, such as a call mode, a recording mode, and a voice recognition mode. The received audio signal may be further stored in the memory 404 or transmitted via the communication component 416. In some embodiments, the audio component 410 further includes a speaker to output audio signals.

The I/O interface 412 provides an interface between the processing component 402 and peripheral interface modules, the peripheral interface modules may be a keyboard, a click wheel, buttons, and the like. The buttons may include, but are not limited to: a home button, a volume button, a starting button, and a locking button.

The sensor component 414 includes one or more sensors to provide status assessments of various aspects of the electronic device 400. For instance, the sensor component 414 may detect an open/closed status of the electronic device 400, relative positioning of components, e.g., the display and the keypad, of the electronic device 400, a change in position of the sensor component 414 or a component of the electronic device 400, a presence or absence of user contact with electronic device 400, an orientation or an acceleration/deceleration of the electronic device 400, and a change in temperature of the electronic device 400. The sensor component 414 may include a proximity sensor configured to detect the presence of nearby objects without any physical contact. The sensor component 414 may also include a light sensor, such as a CMOS or CCD image sensor, for use in imaging applications. In some embodiments, the sensor component 414 may also include an accelerometer sensor, a gyroscope sensor, a magnetic sensor, a pressure sensor, or a temperature sensor.

The communication component 416 is configured to facilitate communication, wired or wireless, between the electronic device 400 and other devices. The electronic device 400 can access a wireless network based on a communication standard, such as WiFi, a carrier network (e.g., 2G, 3G, 4G, or 5G), or a combination thereof. In one embodiment, the communication component 416 receives a broadcast signal or broadcast associated information from an external broadcast management system via a broadcast channel. In one embodiment, the communication component 416 further includes a near field communication (NFC) module to facilitate short-range communications. For example, the NFC module may be implemented based on a radio frequency identification (RFID) technology, an infrared data association (IrDA) technology, an ultra-wideband (UWB) technology, Bluetooth (BT) technology, and other technologies.

In the embodiments, the electronic device 400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components for performing the above described methods.

In the embodiments, there is also provided a non-transitory computer-readable storage medium including instructions, such as included in the memory 404, executable by the processor 420 in the electronic device 400, for performing the above-described methods. For example, the non-transitory computer-readable storage medium may be a ROM, a random access memory (RAM), a CD-ROM, a magnetic tape, a floppy disc, an optical data storage device, and the like.

In the embodiments, there is also provided a computer program product including readable program code executable by the processor 420 in the electronic device 400, for performing the above-described methods. In an embodiment, the program code may be stored in a storage medium of the electronic device 400, the storage medium may be a non-transitory computer-readable storage medium, for example, the non-transitory computer-readable storage medium may be a ROM, a random access memory (RAM), a CD-ROM, a magnetic tape, a floppy disc, an optical data storage device, and the like.

FIG. 5 is a block diagram showing an electronic device 500 for image registration according to an embodiment. For example, the electronic device 500 may be provided as a client or a server. Referring to FIG. 5, the electronic device 500 includes a processing component 522, which further includes one or more processors, and a memory resource represented by a memory 532, for storing instructions, for instance applications, that may be executed by the processing component 522. The application programs stored in memory 532 may include one or more modules, each corresponding to a set of instructions. In addition, the processing component 522 is configured to execute the instructions to perform the above described image registration method.

The electronic device 500 may further include a power component 526 configured to perform power management for the electronic device 500, a wired or wireless network interface 550 configured to connect the electronic device 500 to a network, and an input/output (I/O) interface 558. The electronic device 500 may operate an operating system stored in the memory 532, such as Windows Server™, Mac OS X™, Unix™, Linux™, FreeBSD™ or the like.

Other embodiments of the present disclosure will be apparent to those skilled in the art from consideration of the specification and practice of the invention present disclosed disclosure described here. This application is intended to cover any variations, uses, or adaptations of the present disclosure following the general principles thereof and including such departures from the present disclosure as come within known or customary practice in the art. It is intended that the specification and examples be considered as explanatory only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. An image registration method, comprising:
acquiring a target image comprising a target object;
inputting the target image to a preset network model, and outputting position information and rotation angle information of the target object;
obtaining a reference image comprising the target object by querying a preset image database according to the position information and the rotation angle information; and
performing image registration on the target image and the reference image to obtain a corresponding position of the target object of the target image in the reference image.

2. The image registration method according to claim 1, wherein one or more sample images of one or more sample objects are stored in the preset image database, and each sample image comprises a sample object having a scale and/or a perspective different from other sample images.

3. The image registration method according to claim 2, wherein said obtaining the reference image comprising the target object by querying the preset image database according to the position information and the rotation angle information comprises:
in response to determining that at least one sample image of one sample object is stored in the preset image database and this one sample object belongs to a same object type as the target object, querying the preset image database to obtain the reference image satisfying a preset scale condition and a preset perspective condition; or
in response to determining that sample images of a plurality of sample objects are stored in the present image database and at least one of the plurality of sample objects belongs to a same object type as the target object, querying the preset image database to obtain same-type sample images comprising a sample object that belongs to the same object type as the target object, and querying the same-type sample images to obtain the reference image satisfying a preset scale condition and a preset perspective condition;
wherein the preset scale condition indicates that a difference between a scale corresponding to the position information of the target object and a scale of the sample object is within a preset scale range; and the preset perspective condition indicates that a difference between a perspective corresponding to the rotation angle information of the target object and a perspective of the sample object is within a preset perspective range.

4. The image registration method according to claim 1, wherein said performing image registration on the target image and the reference image comprises:
locating a minimum enclosing rectangle encompassing the target object in the target image according to the position information;
determining the minimum enclosing rectangle located in the target image as an object image; and
performing image registration on the object image and the reference image.

5. The image registration method according to claim 4, wherein said performing the image registration on the target image and the reference image comprises:
extracting a first feature descriptor and a second feature descriptor of the target object from the object image and the reference image, respectively;
calculating a distance between the first feature descriptor and the second feature descriptor;
determining the first feature descriptor and the second feature descriptor as a feature point pair in response to determining that the distance satisfies a preset distance condition;
calculating a transformation matrix between the object image and the reference image according to the feature point pair and Perspective N Point (PNP) algorithm; and
mapping the object image to the reference image according to the transformation matrix, wherein points in the object image and the reference image corresponding to a same position in space correspond to each other.

6. The image registration method according to claim 1, wherein the position information comprises coordinate information of the minimum enclosing rectangle of the target object in the target image, the coordinate information at least comprises coordinate information of two vertexes on a diagonal of the minimum enclosing rectangle, and the rotation angle information comprises azimuth angle information, pitch angle information, and roll angle information of the target object.

7. The image registration method according to claim 1, wherein the preset network model is a deep convolutional network model, and the deep convolutional network model is trained by inputting training sample data into the deep convolutional network model, and iteratively adjusting a parameter of each layer of the deep convolutional network model until a result output by the deep convolutional network model meets a preset condition.

8. An electronic device, comprising:
a processor; and
a memory for storing instructions executable by the processor;
wherein the processor is configured to execute the instructions to implement steps comprising:
acquiring a target image comprising a target object;
inputting the target image to a preset network model, and outputting position information and rotation angle information of the target object;
obtaining a reference image comprising the target object by querying a preset image database according to the position information and the rotation angle information; and
performing image registration on the target image and the reference image to obtain a corresponding position of the target object of the target image in the reference image.

9. The electronic device according to claim 8, wherein one or more sample images of one or more sample objects are stored in the preset image database, and each sample image comprises a sample object having a scale and/or a perspective different from other sample images.

10. The electronic device according to claim 9, wherein the processor is configured to:
in response to determining that at least one sample image of one sample object is stored in the preset image database and this one sample object belongs to a same object type as the target object, query the preset image database to obtain the reference image satisfying a preset scale condition and a preset perspective condition; or
in response to determining that sample images of a plurality of sample objects are stored in the preset image database and at least one of the plurality of sample objects belongs to a same object type as the target object, query the preset image database to obtain same-type sample images comprising a sample object that belongs to the same object type as the target object, and query the same-type sample images to obtain the reference image satisfying a preset scale condition and a preset perspective condition;
wherein the preset scale condition indicates that a difference between a scale corresponding to the position information of the target object and a scale of the sample object is within a preset scale range; and the preset perspective condition indicates that a difference between a perspective corresponding to the rotation angle information of the target object and a perspective of the sample object is within a preset perspective range.

11. The electronic device according to claim 8, wherein the processor is configured to:
locate a minimum enclosing rectangle encompassing the target object in the target image according to the position information;
determine the minimum enclosing rectangle located in the target image as an object image; and
perform image registration on the object image and the reference image.

12. The electronic device according to claim 11, wherein the processor is configured to:
extract a first feature descriptor and a second feature descriptor of the target object from the object image and the reference image, respectively;
calculate a distance between the first feature descriptor and the second feature descriptor;
determine the first feature descriptor and the second feature descriptor as a feature point pair in response to determining that the distance satisfies a preset distance condition;
calculate a transformation matrix between the object image and the reference image according to the feature point pair and PNP algorithm; and
map the object image to the reference image according to the transformation matrix, wherein points in the object image and the reference image corresponding to a same position in space correspond to each other.

13. The electronic device according to claim 8, wherein the position information comprises coordinate information of the minimum enclosing rectangle of the target object in the target image, the coordinate information at least comprises coordinate information of two vertexes on a diagonal of the minimum enclosing rectangle, and the rotation angle information comprises azimuth angle information, pitch angle information, and roll angle information of the target object.

14. The electronic device according to claim 8, wherein the preset network model is a deep convolutional network model, and the processor is configured to train the deep convolutional network model by inputting training sample data into the deep convolutional network model, and iteratively adjusting a parameter of each layer of the deep convolutional network model until a result output by the deep convolutional network model meets a preset condition.

15. A non-transitory computer-readable storage medium having stored therein instructions that, in response to the instructions being executed by a processor of an electronic device, cause the electronic device to execute the instructions to implement steps comprising:
acquiring a target image comprising a target object;
inputting the target image to a preset network model, and outputting position information and rotation angle information of the target object;
obtaining a reference image comprising the target object by querying a preset image database according to the position information and the rotation angle information; and
performing image registration on the target image and the reference image to obtain a corresponding position of the target object of the target image in the reference image.

16. The non-transitory computer-readable storage medium according to claim 15, wherein one or more sample images of one or more sample objects are stored in the preset image database, and each sample image comprises a sample object having a scale and/or a perspective different from other sample images.

17. The non-transitory computer-readable storage medium according to claim 16, wherein said obtaining the reference image comprising the target object by querying the preset image database according to the position information and the rotation angle information comprises:
in response to determining that at least one sample image of one sample object is stored in the preset image database and this one sample object belongs to a same object type as the target object, querying the preset image database to obtain the reference image satisfying a preset scale condition and a preset perspective condition; or
in response to determining that sample images of a plurality of sample objects are stored in the preset image database and at least one of the plurality of sample objects belongs to a same object type as the target object, querying the preset image database to obtain same-type sample images comprising a sample object that belongs to the same object type as the target object, and querying the same-type sample images to obtain the reference image satisfying a preset scale condition and a preset perspective condition;
wherein the preset scale condition indicates that a difference between a scale corresponding to the position information of the target object and a scale of the sample object is within a preset scale range; and the preset perspective condition indicates that a difference between a perspective corresponding to the rotation angle information of the target object and a perspective of the sample object is within a preset perspective range.

18. The non-transitory computer-readable storage medium according to claim 15, wherein said performing image registration on the target image and the reference image comprises:
locating a minimum enclosing rectangle encompassing the target object in the target image according to the position information;
determining the minimum enclosing rectangle located in the target image as an object image; and
performing image registration on the object image and the reference image.

19. The non-transitory computer-readable storage medium according to claim 18, wherein said performing the image registration on the target image and the reference image comprises:
extracting a first feature descriptor and a second feature descriptor of the target object from the object image and the reference image, respectively;
calculating a distance between the first feature descriptor and the second feature descriptor;
determining the first feature descriptor and the second feature descriptor as a feature point pair in response to determining that the distance satisfies a preset distance condition;
calculating a transformation matrix between the object image and the reference image according to the feature point pair and PNP algorithm; and
mapping the object image to the reference image according to the transformation matrix, wherein points in the object image and the reference image corresponding to a same position in space correspond to each other.

20. The non-transitory computer-readable storage medium according to claim 15, wherein the position information comprises coordinate information of the minimum enclosing rectangle of the target object in the target image, the coordinate information at least comprises coordinate information of two vertexes on a diagonal of the minimum enclosing rectangle, and the rotation angle information comprises azimuth angle information, pitch angle information, and roll angle information of the target object.
